(19) United States
(12) Patent Application Publication
(10) Pub. No.: US 2008/0027566 A1
(43) Pub. Date: Jan. 31, 2008

(54) Home Network System

(76) Inventors: Seung-Myun Baek, Kyungsangnam-Do (KR); Koon-Seok Lee, Kyungsangnam-do (KR); Hwan-Jong Choi, Busan (KR); Yong-Tae Kim, Kyungsangnam-do (KR); Feel-Young Koo, Busan (KR); Ja-In Koo, Kyungsangnam-do (KR); Seong-Hwan Kang, Kyungsangnam-do (KR)

Correspondence Address: McKenna Long & Aldridge, 1900 K Street N W, Washington, DC, 20006, US

(21) Appl. No.: 10/560,253

(22) PCT Filed: May 28, 2004
(86) PCT No.: PCT/KR04/01261

§ 371 Date: Feb. 9, 2007

(30) Foreign Application Priority Data
May 30, 2003 (KR) 10-2003-0034962
Jul. 7, 2003 (KR) PCT/KR03/01345

(51) Int. Cl. H04L 29/06; G06F 17/00

(52) U.S. Cl. 700/3; 700/90; 709/208

(57) ABSTRACT

The present invention discloses a home network system (100) which uses a message structure for efficient communication between a plurality of home appliances. The home network system (100) includes at least one slave device (60, 70, 80), and at least one master device (50) connected to the slave device (60, 70, 80) through a network (90), for transmitting a request message to the slave device (60, 70, 80), wherein the request message is transmitted from an upper layer of the master device (50) to a lower layer thereof and from a lower layer of the slave device (60, 70, 80) to an upper layer thereof, and has a command code implying an operation which will be executed by the slave device (60, 70, 80), and a related argument for executing the operation.

### TECHNICAL FIELD

The present invention relates to a home network system, and more particularly to, a home network system which uses a message structure for efficient communication between a plurality of home appliances.

### BACKGROUND ART

Home automation for automatically controlling home appliances at home or remotely has almost reached a commercial use stage. At its early stage, the home automation separately controlled each home appliance by using a telephone or infrared rays, and did not connect the home appliances one another. However, there has been suggested a method for building a network of home appliances by using a communication means, and collectively managing the network by using a controller.

FIG. 1 is a structure view illustrating a general home network system. Referring to FIG. 1, a home network connects various digital home appliances so that a user can always enjoy convenient, safe and economic life services inside or outside the house.

As factors of the advent of the home network, refrigerators or washing machines called white home appliances have been gradually digitalized due to development of digital signal processing techniques, and new information home appliances have been made due to rapid development of home appliance operating system techniques and high speed multimedia communication techniques.

Here, an IT network is built to exchange data between a personal computer and peripheral devices or provide internet services, and an AV network is built between home appliances using audio or video information. In addition, a living network is built to simply control home appliances, such as home automation or remote meter reading, and may be comprised of a refrigerator, washing machine, microwave oven, electric lamp, gas alarm, air conditioner and telephone.

The home network system includes a master device which is a home appliance for controlling an operation of the other home appliances or monitoring a status thereof, and a slave device which is a home appliance having a function of responding to the request of the master device and a function of notifying a status change according to properties of the home appliances or other factors. Here, the home appliances (or new devices) include home appliances for the living network service such as a washing machine and a refrigerator as well as home appliances for the IT network service and the AV network service.

In the conventional home network system, there are increasing demands for a message structure for precisely transmitting information between a plurality of home appliances (master devices and slave devices) connected to the home network system.

### DISCLOSURE OF THE INVENTION

An object of the present invention is to provide a home network system which can efficiently transmit a control command, by transmitting a request message having a predetermined structure from a master device to a slave device by using layers between home appliances (master device and slave device).

Another object of the present invention is to provide a home network system which can efficiently transmit a response, control a network traffic and implement optimum performance of home appliances (master device and slave device), by transmitting a response message having a predetermined structure from a slave device to a master device in response to a predetermined request message by using layers between the home appliances.

Yet another object of the present invention is to provide a home network system which can efficiently notify an event, by transmitting an event message having a predetermined structure from one home appliance to another home appliance by using layers between the home appliances.

In order to achieve the above-described objects of the invention, there is provided a home network system including: at least one slave device; and at least one master device connected to the slave device through a network, for transmitting a request message to the slave device, wherein the request message is transmitted from an upper layer of the master device to a lower layer thereof and from a lower layer of the slave device to an upper layer thereof, and has a command code implying an operation which will be executed by the slave device, and a related argument for executing the operation.

According to another aspect of the invention, a home network system includes: at least one master device; and a slave device connected to the master device through a network, for receiving a request message from the master device and transmitting a response message to the master device, wherein the response message is transmitted from an upper layer of the slave device to a lower layer thereof and from a lower layer of the master device to an upper layer thereof, and has a command code included in the request message for implying an operation which will be executed by the slave device, and a field for executing the request.

Preferably, when the request message has been normally executed, the field includes an ACK code.

Preferably, the response message further includes a field for notifying an execution result of the request message.

Preferably, when the request message has not been normally executed, the field includes an NAK code.

Preferably, the command code includes an instantaneous command for allowing the slave device to receive the request message, directly execute the request message, and then transmit the response message.

Preferably, the command code includes a program command for allowing the slave device to receive the request message, transmit the response message to the master device, and then execute the request message.

Preferably, the related argument is an argument independent from the command code.

Preferably, the related argument is an argument dependent upon the command code.

According to another aspect of the invention, a home network system includes at least two devices, wherein, when a status of one device is changed, one device generates an event message and transmits the event message to the other device, and the event message is transmitted from an upper layer of one device to a lower layer thereof and from a lower layer of the other device to an upper layer thereof, and has a command code, an event code and a status value.

Preferably, the command code is ‘0×11’.

According to another aspect of the invention, a storage medium records a message structure in a home network system including at least one master device and slave device, wherein a request message from the master device to the slave device is transmitted from an upper layer of the master device to a lower layer thereof and from a lower layer of the slave device to an upper layer thereof, and has a command code implying an operation which will be executed by the slave device, and a related argument for executing the operation.

According to another aspect of the invention, a storage medium records a message structure in a home network system including at least one master device and slave device, wherein a response message to a request message from the master device to the slave device is transmitted from an upper layer of the slave device to a lower layer thereof and from a lower layer of the master device to an upper layer thereof, and has a command code included in the request message for implying an operation which will be executed by the slave device, and a field for executing the request.

Preferably, when the request message has been normally executed, the field includes an ACK code.

Preferably, the message structure further includes a field for notifying an execution result of the request message.

Preferably, when the request message has not been normally executed, the field includes an NAK code.

Preferably, the command code includes an instantaneous command for allowing the slave device to receive the request message, directly execute the request message, and transmit the response message.

Preferably, the command code includes a program command for allowing the slave device to receive the request message, transmit the response message to the master device, and execute the request message.

Preferably, the related argument is an argument independent from the command code.

Preferably, the related argument is an argument dependent upon the command code.

According to another aspect of the invention, a storage medium records a message structure in a home network system including at least two devices, wherein an event message generated due to status change of one device is transmitted from an upper layer of one device to a lower layer thereof and from a lower layer of the other device to an upper layer thereof, and has a command code, an event code and a status value.

Preferably, the command code is ‘0×11’.

### BRIEF DESCRIPTION OF THE DRAWINGS

FIG. 1 is a structure view illustrating a general home network system;

FIG. 2 is a structure view illustrating a home network system in accordance with the present invention;

FIG. 3A is a structure view illustrating a request message in accordance with the present invention;

FIG. 3B is a structure view illustrating a first example of a response message in accordance with the present invention;

FIG. 3C is a structure view illustrating a second example of the response message in accordance with the present invention; and

FIG. 3D is a structure view illustrating an event message in accordance with the present invention.

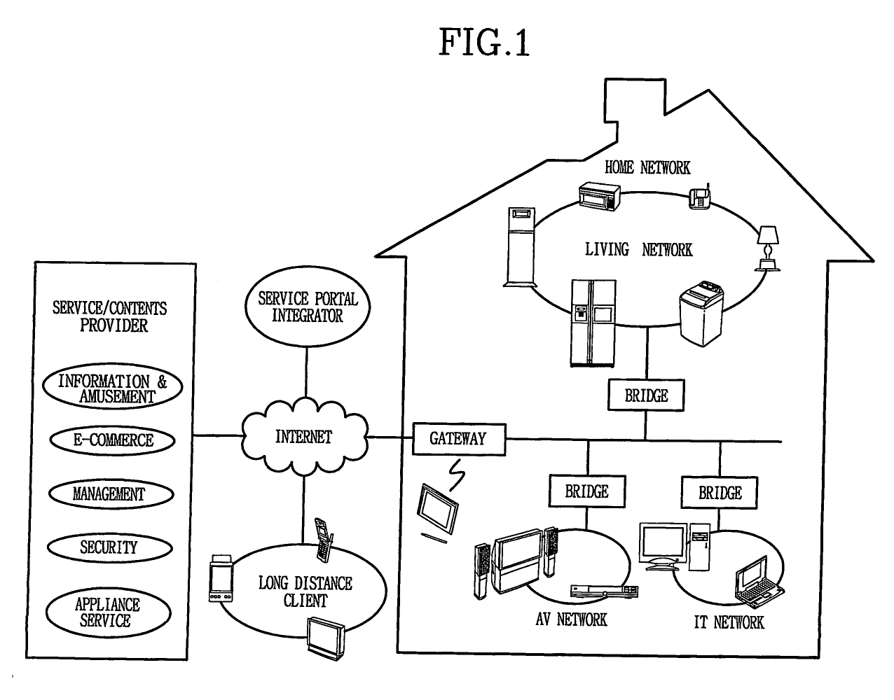

### BEST MODE FOR CARRYING OUT THE INVENTION

A home network system in accordance with the present invention will now be described in detail with reference to the accompanying drawings.

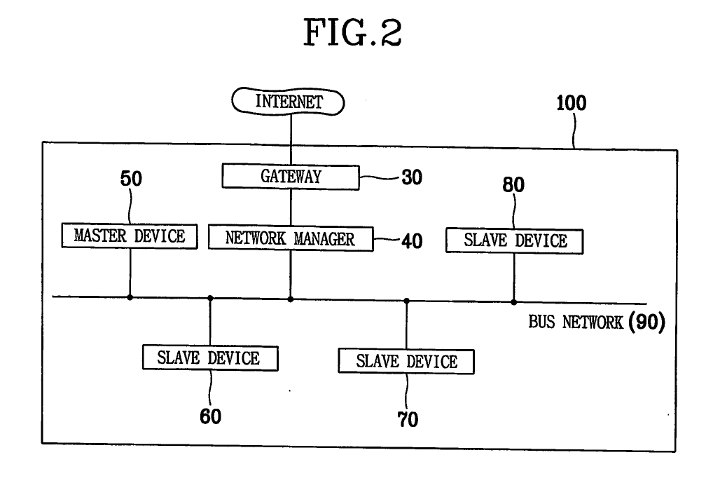

FIG. 2 is a structure view illustrating the home network system in accordance with the present invention. Referring to FIG. 2, the home network system 100 includes at least one master device 50 and slave devices 60, 70 and 80 connected through a bus network 90. In addition, the home network system 100 further includes a gateway 30 for access to an external network (for example, internet), and a network manager 40 connected to the gateway 30, for providing an internet service and performing environment setting and resetting functions of home appliances of the home network system 100.

Here, the master device 50 performs the same functions as the general master device, and the network manager 40 performs similar functions to the master device 50 except for the internet service. For conveniences' shake, there are presumed that the network manager 40 performs functions such as a bridge for the internet service, and that only one master device 50 exists in the home network system 100.

The bus network 90 can be a wire medium such as a specially-installed line, or a previously-installed power line or telephone line, or a wireless transmission medium. However, still referring to FIG. 2, the home network system 100 composes a closed network for connecting home appliances of one house through a wire or wireless transmission medium. At this time, the closed network includes a physically-connected but logically-divided network. In addition, the bus network 90 of the home network system 100 pursues to a different protocol from the external network. It is thus impossible to access the home appliances merely through the external network.

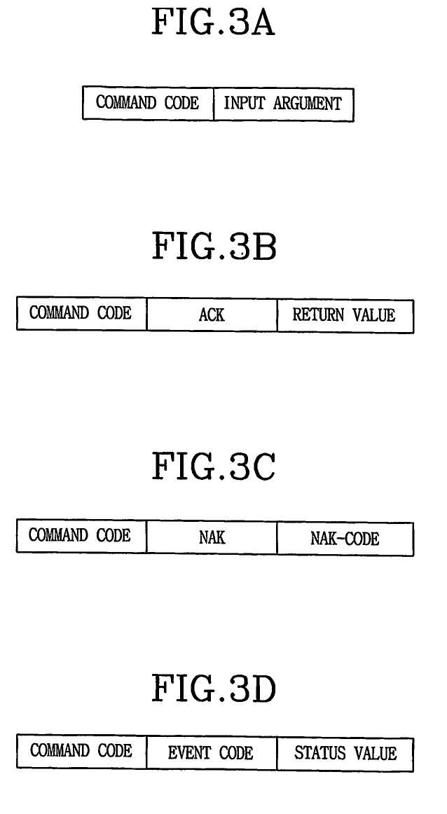

FIG. 3A is a structure view illustrating a request message in accordance with the present invention. As shown in FIG. 3A, the request message is transmitted from the master device 50 to the slave devices 60, 70 and 80, and has a command code for allowing the slave devices 60, 70 and 80 to execute a predetermined operation, and a related argument for executing the operation.

The related argument included in the request message is a data necessary to execute a control command according to the command code. The related argument is classified into an independent argument independent from the command code, and a dependent argument dependent upon the command code. For example, the independent argument is a voice data or an image data. When the command code implies transmission of a predetermined data, the independent argument is included in the request message. The independent argument itself has inherent characteristics, and such characteristics are not changed by the command code. On the other hand, for example, the dependent argument is a predetermined constant. When the command code implies temperature setting of a refrigerator, the dependent argument is regarded as a set temperature value, and when the command code implies operation start of a microwave oven, the dependent argument is regarded as an operation time value. That is, the dependent argument does not have inherent characteristics, but characteristics thereof are determined by the command code.

The related argument can be used as the independent argument or the dependent argument according to intentions of the designer designing the home network system 100, or properties of each home appliance.

The request message is transmitted from an upper layer of the master device 50 to a lower layer thereof under a predetermined control protocol of the home network system 100, and transmitted from lower layers of the slave devices 60, 70 and 80 to upper layers thereof through the bus network 90. Accordingly, control means (not shown) of the slave devices 60, 70 and 80 receive the request message and perform a predetermined operation.

FIG. 3B is a structure view illustrating a first example of a response message in accordance with the present invention. As depicted in FIG. 3B, the response message is a response to the request message of FIG. 3A, and has a command code included in the request message, an ACK (acknowledgement) and a return value.

The command code is a previously-inputted command code from the master device 50, which has been processed or will be processed in the slave devices 60, 70 and 80, the ACK implies that the request message has been normally executed, and the return value implies an execution result of the request message.

FIG. 3C is a structure view illustrating a second example of the response message in accordance with the present invention. As illustrated in FIG. 3C, the response message is a response to the request message of FIG. 3A, and has a command code included in the request message, an NAK (no acknowledgement) and an NAK code (or error code).

The command code is a previously-inputted command code from the master device 50, which has been processed or will be processed in the slave devices 60, 70 and 80, the NAK implies that the request message has not been normally executed, and the NAK code implies a non-execution reason. Here, the NAK code does not include transmission errors resulting from communication failure by message transmission.

Such response messages are transmitted from the upper layers of the slave devices 60, 70 and 80 to the lower layers thereof under a predetermined control protocol of the home network system 100, and transmitted from the lower layer of the master device 50 to the upper layer thereof through the bus network 90. Accordingly, a control means (not shown) of the master device 50 receives and processes the response messages.

The command codes of FIGS. 3A to 3C are divided into an instantaneous command code and a program command code. The instantaneous command code can be executed by the slave devices 60, 70 and 80 directly after reception. When the slave devices 60, 70 and 80 receive the request message containing the instantaneous command code, the slave devices 60, 70 and 80 must transmit the response message after executing the command. The program command code requires a sequence for execution. When the slave devices 60, 70 and 80 receive the request message containing the program command code, the slave devices 60, 70 and 80 must execute the command after transmitting the response message.

Here, characteristics of the instantaneous or program command code are determined by estimating a traffic of the whole network including the bus network 90 not to generate an excessive traffic, or determined in consideration of properties of each home appliance to process data with optimum performance.

FIG. 3D is a structure view illustrating an event message in accordance with the present invention. Referring to FIG. 3D, the event message has a command code for notifying the event message, an event code and a status value.

The event message is generated because of status changes of the home appliances (master device 50 and slave devices 60, 70 and 80). According to generation reasons, event messages are classified into a user event generated due to a command directly from the user, a periodical event automatically generated at an interval of a predetermined time, a status event generated due to spontaneous status change during monitoring of the status of the home appliance, an error event generated due to an error relating to the operation of the home appliance, and an external event generated due to a request from the outside of the home network system 100.

In the case that the user (or master device 50) monitors the status of the home appliance, it is inefficient for the user to request the status value whenever he/she intends to know the status of the home appliance. That is, when the status value of the home appliance is changed, the home appliance can efficiently notify the status change by using the event message. In addition, a process for directly notifying the status change when the event is generated is necessary in order to directly notify a defect or error of the home appliance.

The event message uses the command code of 0×11, the event code contains a product code implying the home appliance relating to the event and an event type, and the return value contains information of a value changed due to the event.

The message structures can be stored in a predetermined storage means of the master device and the slave device of the home network system, or transmitted through the bus network.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A home network system, comprising:
at least one slave device; and
at least one master device connected to the slave device through a network, for transmitting a request message to the slave device,
wherein the request message is transmitted from an upper layer of the master device to a lower layer thereof and from a lower layer of the slave device to an upper layer thereof, and has a command code implying an operation which will be executed by the slave device, and a related argument for executing the operation.

2. A home network system, comprising:
at least one master device; and
a slave device connected to the master device through a network, for receiving a request message from the master device and transmitting a response message to the master device,
wherein the response message is transmitted from an upper layer of the slave device to a lower layer thereof and from a lower layer of the master device to an upper layer thereof, and has a command code included in the request message for implying an operation which will be executed by the slave device, and a field for executing the request.

3. The system of claim 2, wherein, when the request message has been normally executed, the field comprises an ACK code.

4. The system of claim 3, wherein the response message further comprises a field for notifying an execution result of the request message.

5. The system of claim 2, wherein, when the request message has not been normally executed, the field comprises an NAK code.

6. The system of claim 1 or 2, wherein the command code comprises an instantaneous command for allowing the slave device to receive the request message, directly execute the request message, and then transmit the response message.

7. The system of claim 1 or 2, wherein the command code comprises a program command for allowing the slave device to receive the request message, transmit the response message to the master device, and then execute the request message.

8. The system of claim 1, wherein the related argument is an argument independent from the command code.

9. The system of claim 1, wherein the related argument is an argument dependent upon the command code.

10. A home network system, comprising at least two devices,
wherein, when a status of one device is changed, one device generates an event message and transmits the event message to the other device, and the event message is transmitted from an upper layer of one device to a lower layer thereof and from a lower layer of the other device to an upper layer thereof, and has a command code, an event code and a status value.

11. The system of claim 10, wherein the command code is ‘0×11’.

12. A storage medium for recording a message structure in a home network system including at least one master device and slave device,
wherein a request message from the master device to the slave device is transmitted from an upper layer of the master device to a lower layer thereof and from a lower layer of the slave device to an upper layer thereof, and has a command code implying an operation which will be executed by the slave device, and a related argument for executing the operation.

13. A storage medium for recording a message structure in a home network system including at least one master device and slave device,
wherein a response message to a request message from the master device to the slave device is transmitted from an upper layer of the slave device to a lower layer thereof and from a lower layer of the master device to an upper layer thereof, and has a command code included in the request message for implying an operation which will be executed by the slave device, and a field for executing the request.

14. The medium of claim 13, wherein, when the request message has been normally executed, the field comprises an ACK code.

15. The medium of claim 14, wherein the message structure further comprises a field for notifying an execution result of the request message.

16. The medium of claim 13, wherein, when the request message has not been normally executed, the field comprises an NAK code.

17. The medium of claim 12 or 13, wherein the command code comprises an instantaneous command for allowing the slave device to receive the request message, directly execute the request message, and transmit the response message.

18. The medium of claim 12 or 13, wherein the command code comprises a program command for allowing the slave device to receive the request message, transmit the response message to the master device, and execute the request message.

19. The medium of claim 12, wherein the related argument is an argument independent from the command code.

20. The medium of claim 12, wherein the related argument is an argument dependent upon the command code.

21. A storage medium for recording a message structure in a home network system including at least two devices,
wherein an event message generated due to status change of one device is transmitted from an upper layer of one device to a lower layer thereof and from a lower layer of the other device to an upper layer thereof, and has a command code, an event code and a status value.

22. The medium of claim 21, wherein the command code is ‘0×11’.
